(19) United States
(12) Patent Application Publication
(10) Pub. No.: US 2011/0185491 A1
(43) Pub. Date: Aug. 4, 2011

(54) SUBMERSIBLE STANCHION FOR SUPPORTING SWIMMING POOL ACCESSORIES

(76) Inventor: Adam H. Roberts, Williamsburg, VA (US)

(21) Appl. No.: 12/699,232

(22) Filed: Feb. 3, 2010

(51) Int. Cl. E04H 4/00; B23P 17/04

(52) U.S. Cl. 4/496; 29/428

(57) ABSTRACT

A submersible stanchion is disclosed that provides a lightweight yet durable mounting system that will allow pool users to support a wide variety of accessories such a stool, table, ice bucket or wine cooler bucket, volleyball/badminton net, and so on. The submersible stanchion includes a pedestal base, column, accessory attachment point, at least one weight distributed in a balanced manner about the column, and serving to hold the pedestal base in place upon the bottom of the swimming pool. The pedestal base is submerged and placed on a bottom of a swimming pool. The column couples at a distal end to the pedestal base and extends in a perpendicular direction from the base. The accessory attachment point couples to a proximal end, which may be located below, at or above the surface of the swimming pool.

### FIELD

The present invention generally relates to swimming pool accessories and more particularly to support systems for use in swimming pools.

### BACKGROUND

A swimming pool (in-ground swimming pool, above-ground swimming pool, water hole, or any shallow swimmable area that can be used recreationally) is a popular environment for relaxing. Often, one finds the effort needed to lift one's self out of the pool requires more energy than a relaxed person wishes to exert.

It is often desirable to set up certain recreational items inside the swimming pool, rather than requiring one to exit the pool to use the recreational items. Furthermore, it can be uncomfortable for one who spends a significant portion of time in a pool to exit the pool just to get a portable recreational item. This is particularly true for an above-ground pool wherein one must exit the pool by climbing up one side of a ladder and then down the other side of the ladder to exit the pool, and on the return, again climb up, over, and then down into the pool.

During usage of a swimming pool, it can be useful to be able to easily access recreational items within the pool itself. For example, when lounging in a swimming pool or a hot tub, a seating surface that allows one to remain partially submerged can be desirable, in that it helps one avoid being chilled by being exposed to the air. A table or other surface could also be useful for a variety of purposes. A surface located above the water surface would be useful for serving food and drinks and even for reading. A bench or stool that is slightly submerged upon which one could sit would similarly also be valuable. It would also be desirable to be able to attach a game, such as a pole supporting a backstop and hoop so that a type of basketball or volleyball could be played while in the pool.

Underwater supports for devices such as seats, umbrellas or tables are known. However, these types of devices can be cumbersome and/or heavy to remove or replace with other desired devices. While certain devices such as seats may be appropriate in some pool settings, such as a cocktail party, different devices such as volleyball nets may be appropriate in other settings, such as a recreational game environment. Furthermore, general support structures for some devices, such as a seat, might lack the strength and stability to support other devices, such as a table; or alternatively, they may be heavier than desired when being used to support lighter devices, such as a beverage bucket. However, those support structures which are heavy and strong enough to support larger structures, can be difficult to relocate within the pool, and/or can be difficult to remove from the pool.

### SUMMARY

Embodiments of the present invention are directed to systems and methods that are further described in the following description and claims. Advantages and features of embodiments of the present invention will be apparent from the description, accompanying drawings and claims.

These embodiments provide a lightweight (yet durable) underwater stanchion that supports a wide variety of objects and surfaces. Further, the underwater stanchion can keep the objects and surfaces in a pre-determined position or area of the pool. For example, in one embodiment, the stanchion can support a stool that allows users to partially submerge themselves in water while sitting upright. The larger base provided at the bottom of the stanchion serves to distribute the weight of the objects and surfaces and to keep the objects and surfaces in a pre-placed area. The embodiments of the present invention facilitates the adding and/or removing of appropriate weights to provide appropriate strength and stability to the stanchion, depending upon the item which is meant to be supported. Further, these embodiments allow users to adapt to changing demands associated with different uses of the pool.

According to one embodiment of the present invention, a submersible stanchion capable of supporting a variety of accessories is provided. This submersible stanchion provides a lightweight yet durable support system that allows pool users to support a wide variety of accessories, such as a stool, a table, an ice bucket or a wine cooler bucket, and volleyball/badminton net. In one embodiment, a submersible stanchion for supporting accessories in a swimming pool comprises a pedestal base operable to be submerged and placed on a bottom of a swimming pool, a column having a distal end and proximal end, the distal end being coupled to the pedestal base, the column extending perpendicularly from the pedestal base, the column having an accessory attachment point at the proximal end, and at least one detachable weight, the at least one detachable weight being distributed in a balanced manner about the column, the at least one detachable weight serving to hold the pedestal base in place upon the bottom of the swimming pool.

In some embodiments, the accessory attachment point operable to be attached to a seat, a hammock, a pool light, a pool cleaning accessory, a pool cover, an umbrella, an audio entertainment system, a movie screen, a pool alarm, an alert system, a pool fountain, a pool heater, a heater, a stool, a table, an ice bucket or wine cooler bucket, and a sports net support.

In some embodiments, the seat includes a seating surface and a backrest. In other embodiments, the at least one weight includes at least one ring surrounding, the column and resting on the pedestal base. In some of these embodiments, the at least one ring resembles a torpid, and in some other embodiments the at least one ring can be separated into a plurality of ring pieces. In some embodiments the pedestal base and/or the column can be filled with water upon being submerged.

In some embodiments, the at least one weight includes a plurality of rings stacked coaxially on the pedestal base. In other embodiments, the column is height-adjustable. In still other embodiments, the accessory attachment point is configured to allow an accessory to rotate upon the column.

In another embodiment, a submersible system for providing a table in a swimming pool comprises a pedestal base operable to be submerged and placed on a bottom of a swimming pool, a column having a distal end and proximal end, the distal end being coupled to the pedestal base, the column extending perpendicularly from the pedestal base, and the column having an accessory attachment point at the proximal end, a table coupled to the accessory attachment point, and at least one detachable weight, the at least one detachable weight being distributed in a balanced manner about the column, the at least one detachable weight serving to hold the pedestal base in place upon the bottom of the swimming pool.

In one of these embodiments, the at least one weight includes a plurality of rings stacked coaxially on the pedestal base. In other embodiments, at least one ring of the plurality of rings includes a plurality of ring segments. In other embodiments, the pedestal base and/or the column can be filled with water upon being submerged.

In some of these embodiments, the table and the column have a central opening which can receive an umbrella. In other embodiments, the submersible system further comprises at least one seat radially extending from the column.

In another embodiment, a method of assembling a submersible system for providing an accessory in a swimming pool is claimed, the method comprising: submerging a pedestal base on a bottom of a swimming pool, the pedestal base having a column coupled to the pedestal base, the column having a distal end and proximal end, the distal end being coupled to the pedestal base, the column extending perpendicularly from the pedestal base, the column having an accessory attachment point at the proximal end; coupling an accessory to the accessory attachment point; and securing the pedestal base to the bottom of the swimming pool with at least one detachable weight, the at least one detachable weight being distributed in a balanced manner about the column, the at least one detachable weight serving to hold the pedestal base in place upon the bottom of the swimming pool.

In some of these embodiments, the at least one weight includes a plurality of rings stacked coaxially on the pedestal base. In other embodiments, the at least one ring of the plurality of rings includes a plurality of ring segments. In still other embodiments, the pedestal base and/or the column is adapted to be filled with water upon being submerged.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1A is a drawing of a Submersible Stanchion 100 in accordance with embodiments of the present disclosure;

FIG. 1B is a drawing of a Submersible Seating System 150 in accordance with embodiments of the present disclosure;

FIGS. 2A and 2B show various seating options for use with embodiments of the present disclosure;

FIGS. 3A, 3B and 3C show various arrangements of weights with respect to the pedestal base in accordance with the embodiments of the present disclosure;

FIGS. 4A and 4B depict embodiments of a Submersible Seating System 400 in accordance with the embodiments of the present disclosure;

FIG. 5 depicts a Swimming Pool 500 wherein several submersible seating systems 504, 506 and 508, are located at predetermined places within Pool 500 in accordance with the embodiments of the present disclosure;

FIG. 6 depicts another embodiment wherein the horizontal seating surface may be replaced with a separate horizontal surface that may be located above or beneath the water's surface in accordance with the embodiments of the present disclosure

FIGS. 7A and 7B depicts a variety of accessories that may be located above or beneath the water's surface in accordance with the embodiments of the present disclosure; and

FIG. 8 is a logic flow diagram in accordance with embodiments of the present disclosure.

### DETAILED DESCRIPTION

Preferred embodiments of the present invention are illustrated in the FIGs., like numerals being used to refer to like and corresponding parts of the various drawings.

According to one embodiment of the present disclosure, a submersible stanchion operable to support accessories is provided. This submersible stanchion provides a lightweight yet durable support system that will allow pool users to support a wide variety of accessories such as but not limited to a stool, table, ice bucket or wine cooler bucket, volleyball/badminton net, a seat, a hammock, a pool light, a pool cleaning accessory, a pool cover, an umbrella, an audio entertainment system, a movie screen, a pool alarm, a pool fountain, a pool heater, a heater and so on. The submersible stanchion (stem/base) includes a pedestal base, a column, an attachment point for various accessories, and one or more weights detachably distributed about an axis of the column. The pedestal base is operable to be submerged and placed on a bottom of a swimming pool. The column, having a distal and proximal end, couples at the distal end to the pedestal base and extends from the pedestal base towards the surface of the swimming pool. The attachment point allows various accessories to couple to the proximal end and may be located below, at, or above the surface of the swimming pool. Further, the attachment point may be swivelly coupled to the proximal end of the column. The one or more weights detachably distributed about an axis of the column are operable to secure the pedestal base to the bottom of the swimming pool.

According to another embodiment of the present disclosure, a submersible seating system is provided. This submersible seating system provides a lightweight yet durable seating system that will allow pool users to partially submerge themselves in water while sitting upright. The submersible seating system includes a pedestal base, a column, a seat, and one or more weights detachably distributed about an axis of the column. The pedestal base is operable to be submerged and placed on a bottom of a swimming pool. The column, having a distal and proximal end, couples at the distal end to the pedestal base and extends from the pedestal base towards the surface of the swimming pool. The seat is coupled to the proximal end and may be located below the surface of the swimming pool. Further, the seat may be swivelly coupled to the proximal end of the column. The one or more weights detachably distributed about an axis of the column are operable to secure the pedestal base to the bottom of the swimming pool.

Embodiments of the present disclosure provide a lightweight (yet durable) plastic seating system that, when filled with water, will allow pool users to partially submerge themselves in water while sitting upright. The larger base at the bottom serves in distributing the weight of the stool user and to keep the stool in a pre-placed area of the pool when not in use. The seating system may also accommodate hot tubs (shallower water depths). The seat backs/cushion can be offered in different varieties (even custom) removable designs that couple to the central column. The seats can include armrest cup holders, and other related holders (i.e. personal MP3 players).

Embodiments of the present disclosure can be enjoyed by residential pool users or used by resort operators. Resort operators may use them to accommodate the demand for barstools at resort pools with bars/events.

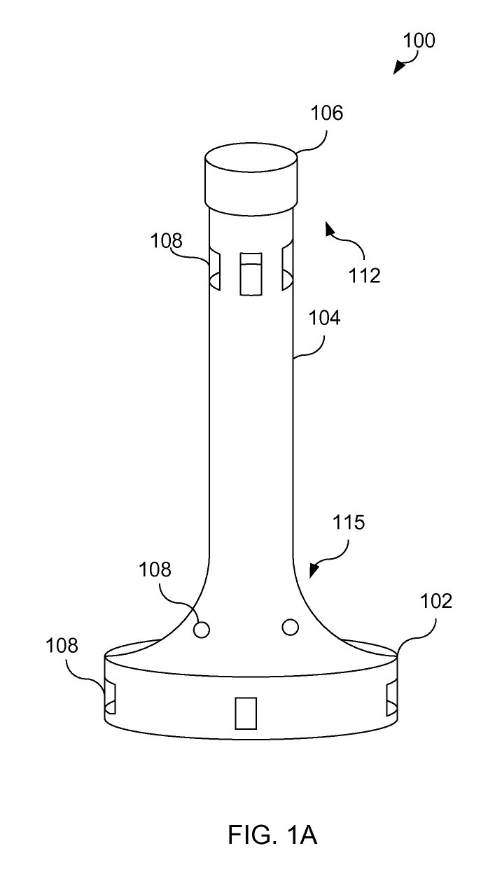

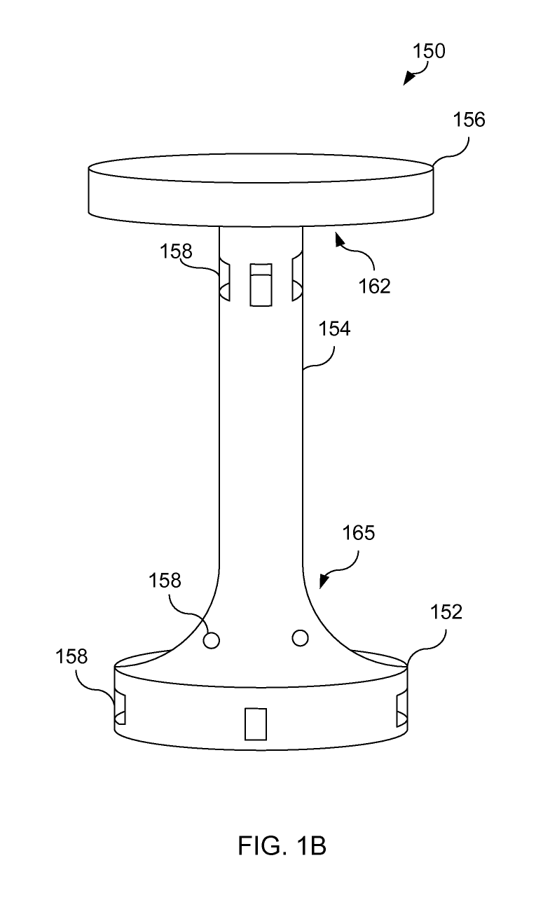

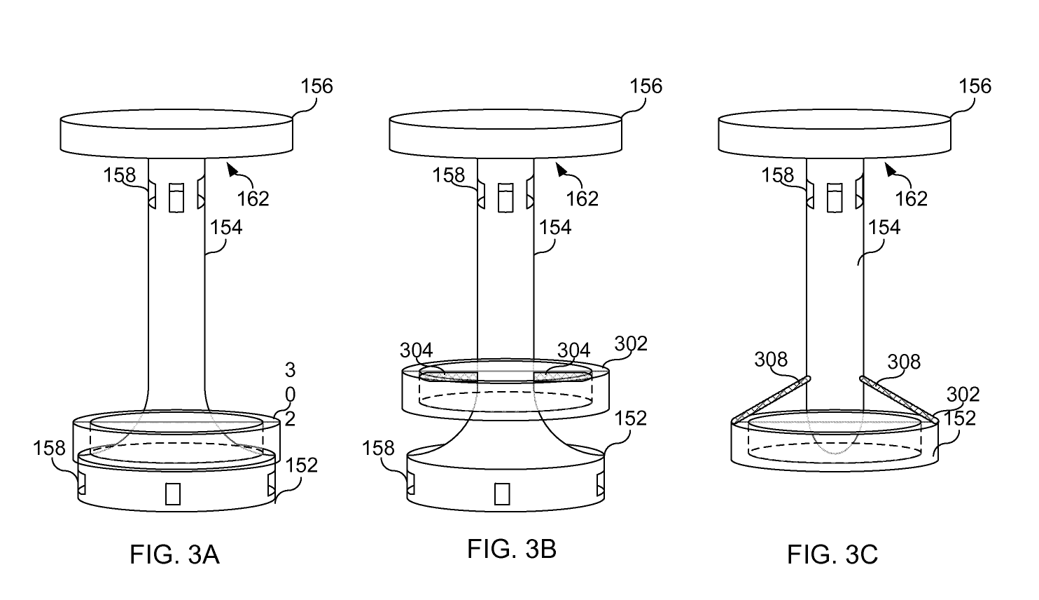

FIG. 1A provides a drawing of a Submersible Stanchion 100 in accordance with embodiments of the present disclosure. Stanchion 100 includes a Pedestal Base 102, a Column 104, a Accessory Mounting point 106, and one or more weights that is not shown in FIG. 1A but will be depicted later with reference to FIG. 3 and following. The pedestal base may be submerged and placed on a bottom of a swimming pool. Column 104 has a Distal End 115 and a Proximal End 112. The distal end couples to the Pedestal Base 102. Column 104 extends from the pedestal base towards the water's surface of a swimming pool. a wide variety of accessories such as but not limited to a stool, table, ice bucket or wine cooler bucket, volleyball/badminton net, and so on couple to Proximal End 112 of Column 104 at Accessory Mounting point 106. The seat may be located below the water's surface of the swimming pool. One or more weights may be detachably distributed about the central axis of a column. The weights secure the pedestal base to the bottom of the swimming pool. Additionally, vents 108 in Column 104 and Pedestal Base 102 allow interior spaces of the pedestal base and column to be flooded with water when submerged.

FIG. 1B provides a drawing of a Submersible Seating System 150 in accordance with embodiments of the present disclosure. Seating System 150 includes a Pedestal Base 152, a Column 154, a Seat 156, and one or more weights that is not shown in FIG. 1 but will be depicted later with reference to FIG. 3 and following. The pedestal base may be submerged and placed on a bottom of a swimming pool. Column 154 has a Distal End 165 and a Proximal End 162. The distal end couples to the Pedestal Base 152. Column 154 extends from the pedestal base towards the water's surface of a swimming pool. Seat 156 couples to Proximal End 162 of Column 154. The seat may be located below the water's surface of the swimming pool. One or more weights may be detachably distributed about the central axis of a column. The weights secure the pedestal base to the bottom of the swimming pool. Additionally, vents 158 in Column 154 and Pedestal Base 152 allow interior spaces of the pedestal base and column to be flooded with water when submerged.

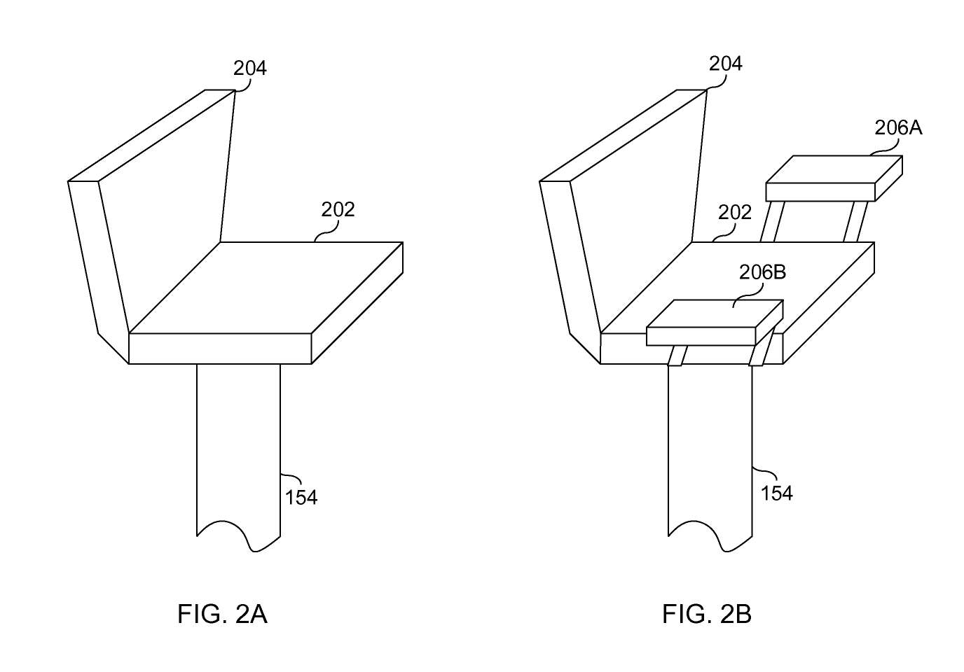

FIGS. 2A and 2B show various seating options for use with embodiments of the present disclosure. FIG. 2A shows a Seating Surface 202 coupled to a Backrest 204. Seats may be swivelly mounted with respect to the pedestal base. This swivel type connection may be achieved with a threaded connection between the seat and the column, a swivel connection between the seat and the column or perhaps there is a swivel connection between the column and the pedestal base. Any combination of these rotatably coupled joints may allow the Seat 202 to swivel with respect to the pedestal base. FIG. 28 shows the addition of Armrest 206A and 206B to Seat 200. Other various options and types of seats although not presented may be incorporated into various embodiments of the present invention.

FIGS. 3A, 3B and 3C show various arrangements of weights with respect to the pedestal base in accordance with embodiments of the present disclosure. FIG. 3A shows a Ring 302 resting on Pedestal Base 152. Ring 302 secures pedestal base 152 and Column 154 to the bottom of the Swimming Pool. FIG. 3B depicts a slightly different arrangement wherein the ring or rings 302, instead of resting directly on Pedestal Base 152, may couple with Supports 304 to the distal end of the Column 154. This secures the distal end and the pedestal base to the bottom of the swimming pool. FIG. 3C shows yet another arrangement where the Pedestal Base 152 of Coupled Column 154 may merely be the same diameter as the Column 154. In this case, Tethers 308 are used to couple the column at the distal end of the column to the ring or Rings 302. In this case, Rings 302 may lie directly on the bottom of the swimming pool. This provides some additional flexibility in the instance where the bottom of the swimming pool is not level at the spot that the seating system is to be placed.

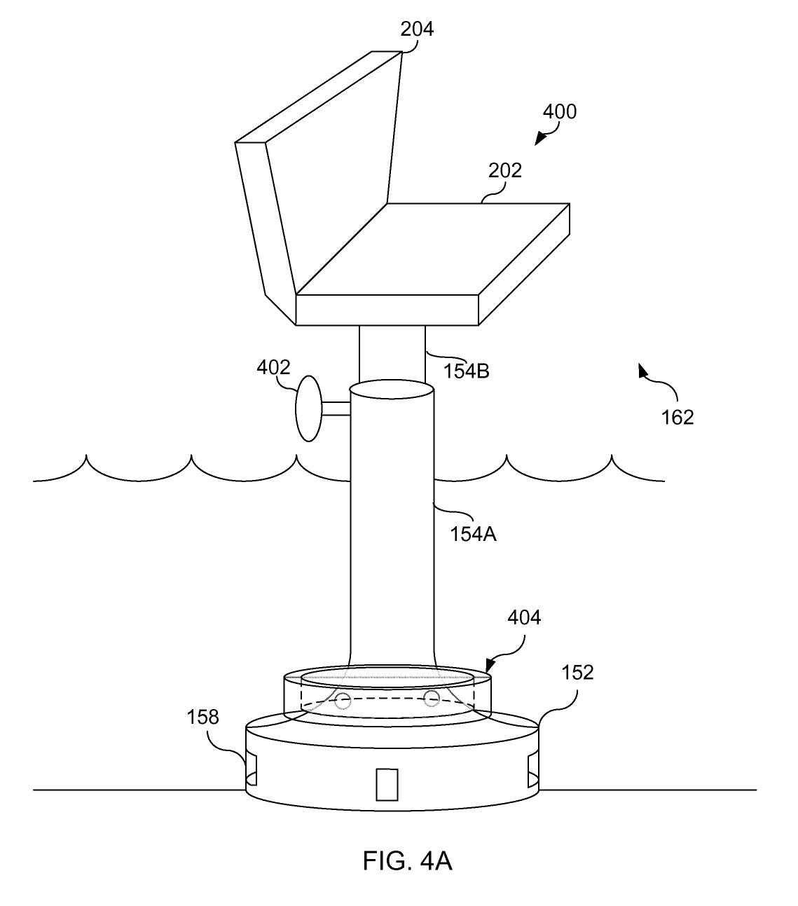

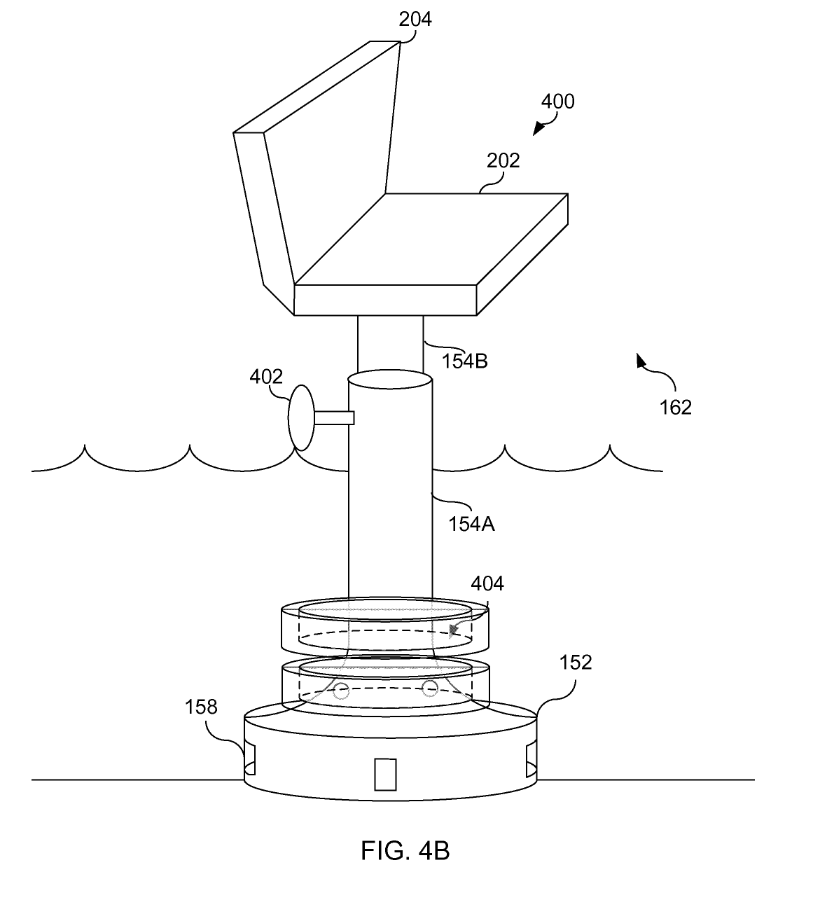

FIGS. 4A and 4B depict embodiments of a Submersible Seating System 400 in accordance with embodiments in the present invention. In this instance, Submersible Seating Systems 400 is located in a swimming pool. FIG. 4A shows a Pedestal Base 152 coupled to a column, which may be telescoping in nature, comprising one or more column segments, which may be locked in place using a Locking Mechanism 402. Column 154 in this instance may comprise a larger diameter Column 154A and smaller diameter or Telescoping Column 154B that couples to Seat 202 shown here having a Backrest 204. As shown in FIGS. 4A and 4B the seat may be located above the water. The weights may be incorporated within Pedestal Base 152 or alternatively may be a ring or series of rings located about Column 154. These rings may be made up of several Segments such as half donuts. Additional rings 404 may be added for additional support. As shown here in FIG. 4A the submersible seating system may become less stable when a user is sitting on Seat 202 without additional Weights 404 about the column. Therefore in FIG. 4B one or more additional weight rings can be added for additional stability.

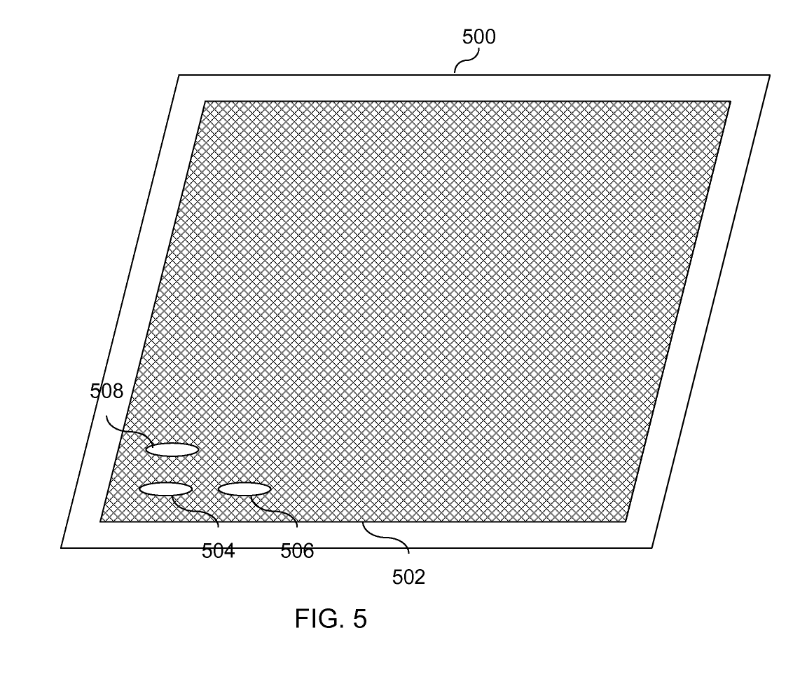

FIG. 5 depicts a Swimming Pool 500 wherein several submersible seating systems 504, 506 and 508, are located at predetermined places within Pool 500. The seats lay beneath the surface of the pool in order to provide a resort-pool feel to a residential or commercial pool. Additionally these types of submersible seating systems may be used to supplement permanently affixed stools in a resort pool.

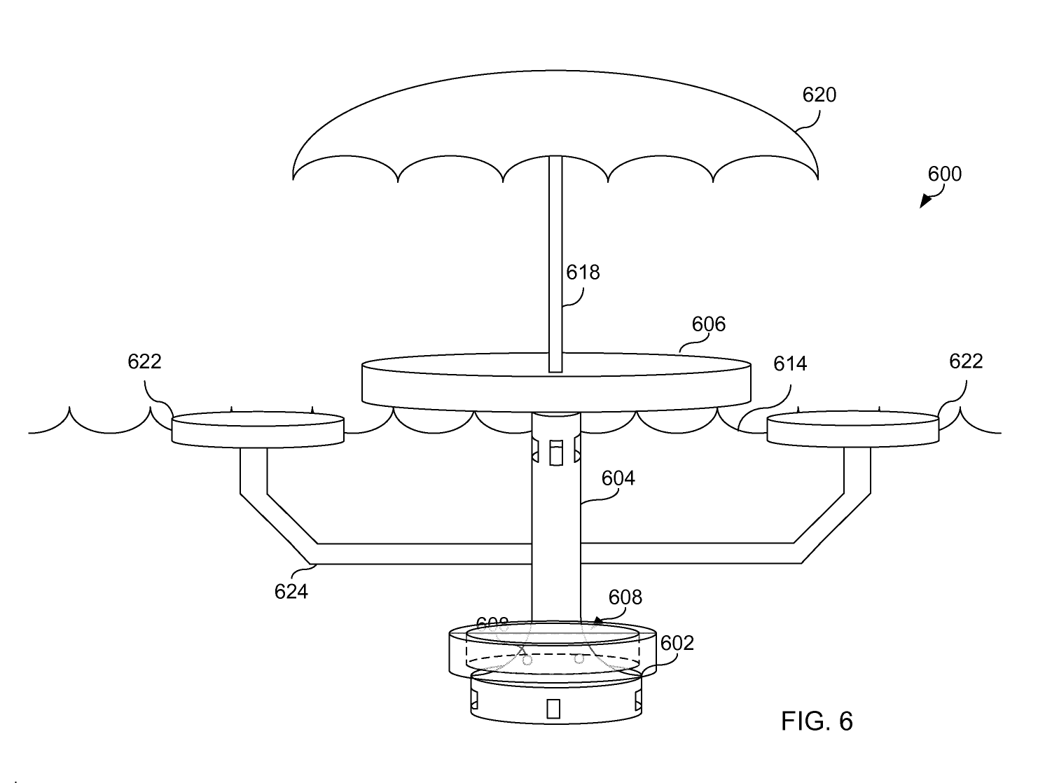

FIG. 6 depicts another embodiment of the present disclosure wherein the horizontal seating surface may be replaced with a different horizontal surface, such as a table, that may be located above or beneath the water's surface in accordance with the embodiments of the present disclosure. Submersible System 600 includes a Pedestal Base 602, a Column 604, and a horizontal surface 606 as well as one or more weights 608. The Pedestal Base 602 may be submerged and placed on Bottom 615, of Swimming Pool 612. The distal end of Column 604 couples to the Pedestal Base 602. The column may be adjustable in height and extends from the Pedestal Base 602 towards a Surface 614 of Swimming Pool 612. A horizontal surface 608 couples to the Proximal End 616 of Column 604. One or more Weights 608, which may be made up of one or more ring segments, may be distributed about a central axis of Column 604. The weight secures the Pedestal Base 602, to the Bottom of the Swimming Pool. As shown here, the weight may comprise a stack of Rings 608 located about the central axis of Column 604. As previously stated, the Column 604 and Pedestal Base 602 may have vents therein which allow water to fill the interior spaces of the column and pedestal base. The Horizontal Surface 606 and Column 604 may have a central opening. The central opening may be used to receive the Support 618 of an Umbrella 620. This further adds to the resort feel of a pool utilizing embodiments of the present disclosure. Also shown is one or more Seats 622 radially extending via Support 624 from Central Column 604.

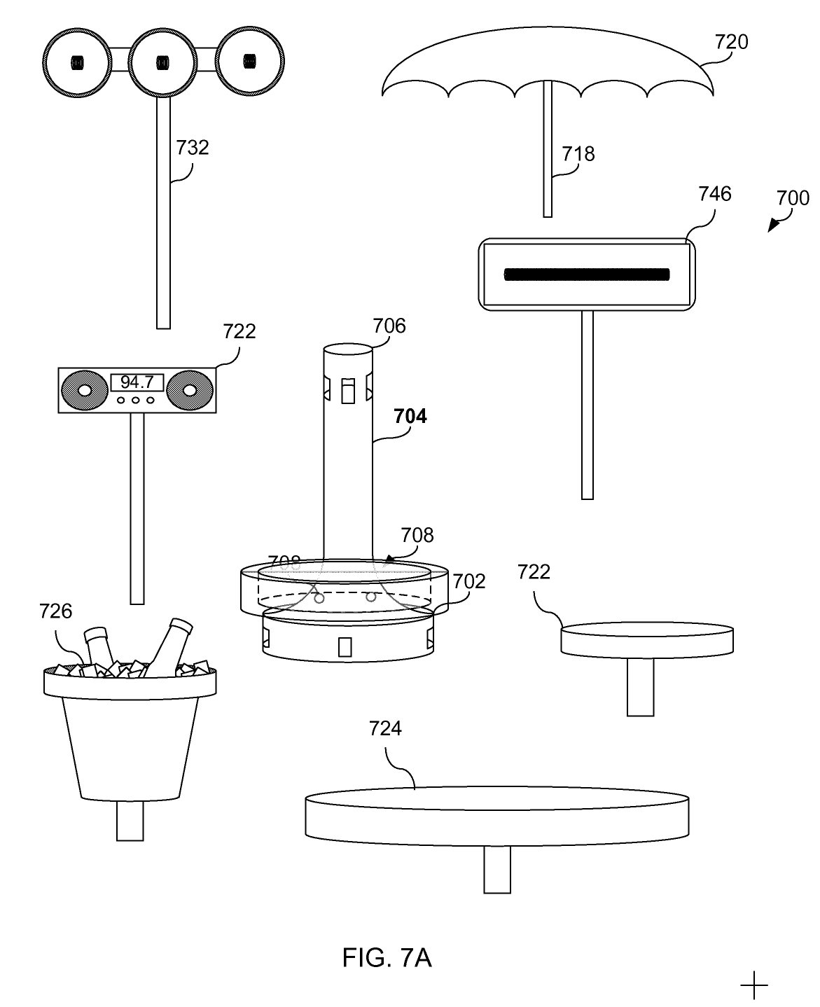

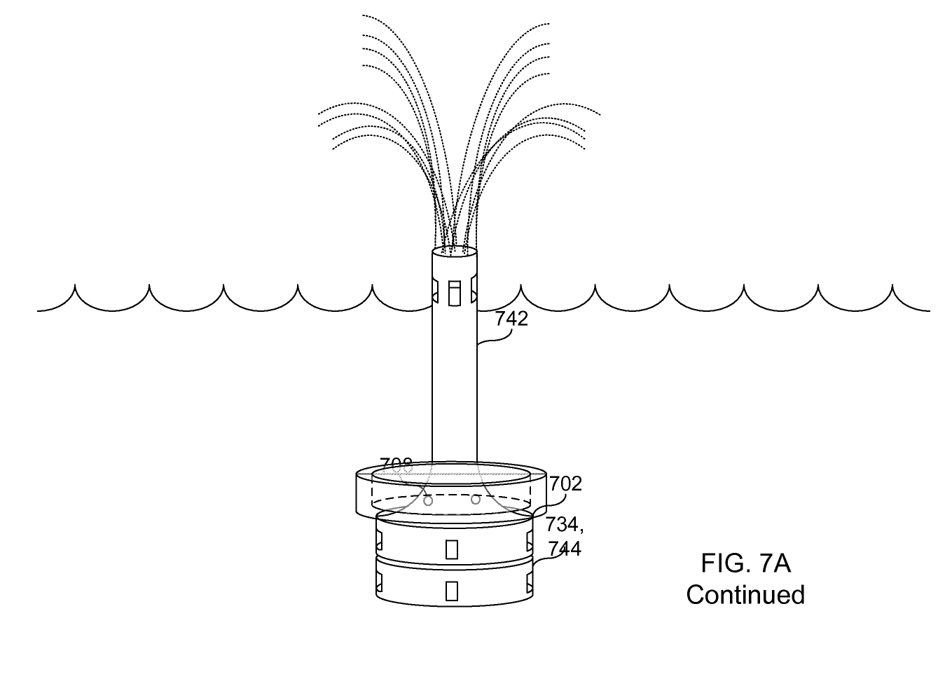

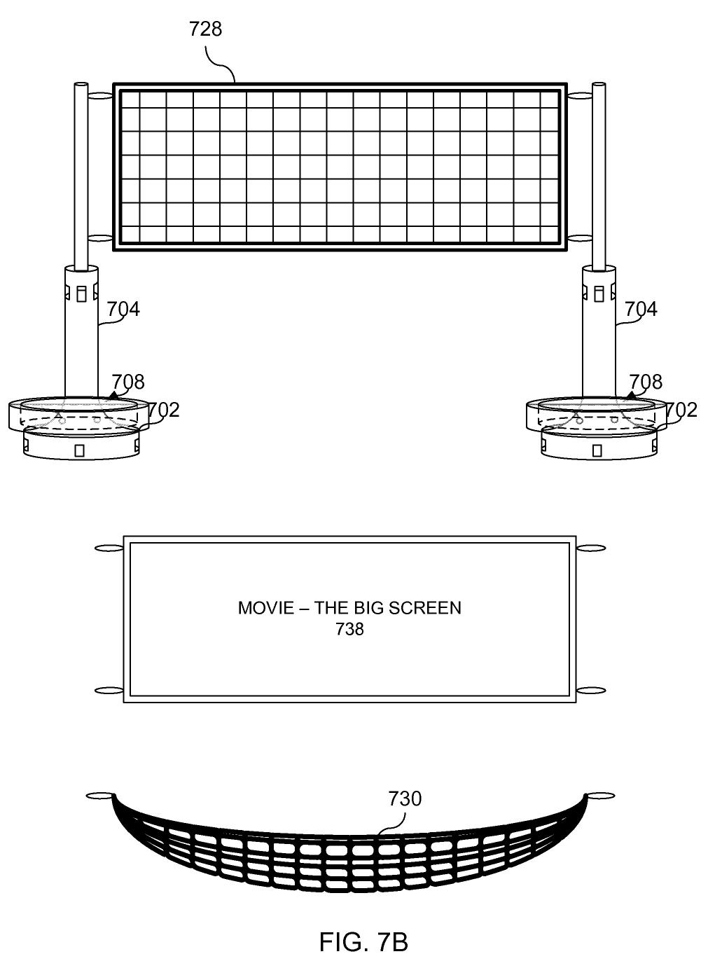

FIGS. 7A and 7B depict a variety of accessories that may be located above or beneath the water's surface in accordance with the embodiments of the present disclosure. FIG. 7B depicts those accessories that may require more than one stanchion. Submersible System 700 includes a Pedestal Base 702, a Column 704, and an accessory attachment point 706 as well as one or more weights 708. The Pedestal Base 702 may be submerged. The distal end of Column 704 couples to the Pedestal Base 702. The column may be adjustable in height and extends from the Pedestal Base 702. An accessory couples to the Proximal End of Column 704 at accessory attachment point 706. One or more Weights 708, which may be made up of one or more ring segments, may be distributed about a central axis of Column 704. The weight secures the Pedestal Base 702, to the Bottom of the Swimming Pool. As shown here, the weight may comprise a stack of Rings 708 located about the central axis of Column 704. As previously stated, the Column 704 and Pedestal Base 702 may have vents therein which allow water to fill the interior spaces of the column and pedestal base. The accessories may include a wide variety of items such as but not limited to a stool 722, table 724, ice bucket 726 or wine cooler bucket 726, volleyball/badminton net 728 (when two or more stanchions are used as shown in FIG. 7B), a seat 722, a hammock 730, a pool light 732, a pool cleaning accessory 734, a pool cover, an umbrella 720, an audio entertainment system 722, a movie screen 738, a pool alarm, a pool fountain 742, a pool heater 744, a heater 746 and so on. Another possible accessory can be a component of an alert system, such as a security alarm system. The components of such an alert system may include at least one security surveillance camera, a sensor, and/or an alert monitor or speaker, for example.

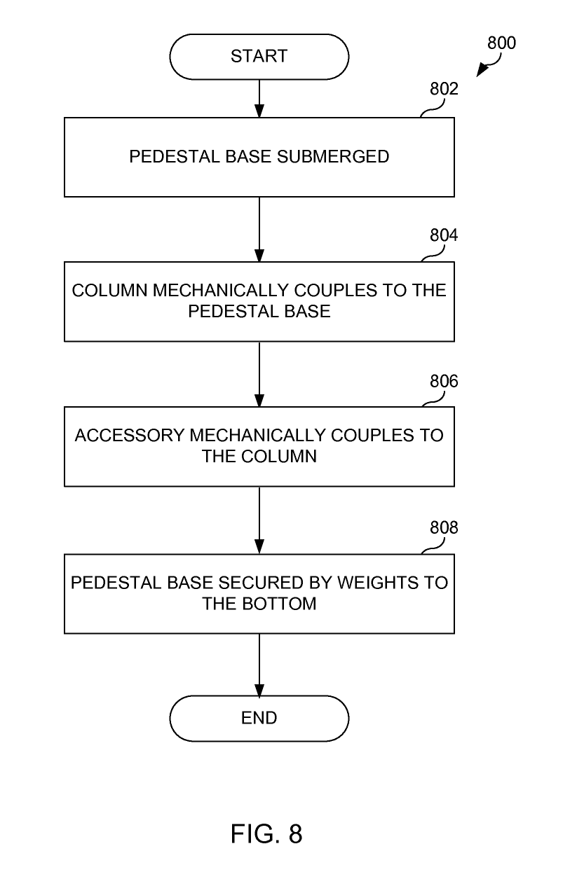

FIG. 8 provides a logic flow diagram in accordance with embodiments of the present disclosure. Operations 800 begin with Block 802 wherein a pedestal base is submerged and placed on the bottom of the swimming pool. In Block 804, a column couples at its distal end to the pedestal base. The column extends from the pedestal base towards the surface of the swimming pool. In Block 806, a wide variety of accessories such as but not limited to a stool, table, ice bucket or wine cooler bucket, volleyball/badminton net and so on couple to the proximal end of the column. The seat or other horizontal surface may be located below or above the water surface of the swimming pool. In Block 808, the pedestal base may be secured to the bottom of the swimming pool with one or more weights detachably distributed about a central axis of the column.

In summary, a submersible stanchion is disclosed in accordance with embodiments of the present disclosure. This submersible stanchion provides a lightweight yet durable mounting system that will allow pool users to mount a wide variety of accessories such as but not limited to a stool, table, ice bucket or wine cooler bucket, volleyball/badminton net and so on couple to the Stanchion. When the accessory is a seat, the seat will allow pool users to partially submerge themselves in water while sitting upright. The submersible stanchion includes a pedestal base, a column, a mounting point, and one or more weights detachably distributed about an axis of the column. The pedestal base is operable to be submerged in place on a bottom of a swimming pool. The column having a distal and proximal end, couples at the distal end to the pedestal base and extends from the pedestal base towards the surface of the swimming pool. This mounting point is coupled to the proximal end, may be located below, at, or above the surface of the swimming pool, and may swivel relative to the proximal end of the column. The one or more weights detachably distributed about an axis of the column are operable to secure the pedestal base to the bottom of the swimming pool.

As one of average skill in the art will appreciate, the term “substantially” or “approximately,” as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled.” As one of average skill in the art will further appreciate, the term “compares favorably,” as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The terminology used herein is for the purpose of describing particular embodiments only and is not intended to be limiting of the invention. As used herein, the singular forms “a” “an” and “the” are intended to include the plural forms as well unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A submersible stanchion for supporting accessories in a swimming pool, the submersible stanchion comprising:
a pedestal base operable to be submerged and placed on a bottom of a swimming pool;
a column having a distal end and proximal end,
the distal end being coupled to the pedestal base,
the column extending perpendicularly from the pedestal base,
the column having an accessory attachment point at the proximal end; and
at least one detachable weight, the at least one detachable weight being distributed in a balanced manner about the column, the at least one detachable weight serving to hold the pedestal base in place upon the bottom of the swimming pool.

2. The submersible stanchion of claim 1, the accessory attachment point operable to be attached to least one accessory selected from the group consisting of
a seat;
a hammock;
a pool light;
a pool cleaning accessory;
a pool cover;
an umbrella;
an audio entertainment system;
a movie screen;
a pool alarm;
an alert system;
a pool fountain;
a pool heater;
a heater;
a stool;
a table;
an ice bucket or wine cooler bucket; and
a sports net support.

3. The submersible stanchion of claim 2, the seat including a seating surface and a backrest.

4. The submersible stanchion of claim 1, wherein the at least one weight includes at least one ring surrounding the column, the at least one ring resting on the pedestal base.

5. The submersible stanchion of claim 4, wherein the at least one ring resembles a toroid.

6. The submersible stanchion of claim 4, wherein the at least one ring can be separated into a plurality of ring pieces.

7. The submersible stanchion of claim 1, wherein at least one of the pedestal base, and the column, can be filled with water upon being submerged.

8. The submersible stanchion of claim 1, wherein the at least one weight includes a plurality of rings stacked coaxially on the pedestal base.

9. The submersible stanchion of claim 1, wherein the column is height-adjustable.

10. The submersible stanchion of claim 1, wherein the accessory attachment point is configured to allow an accessory to rotate upon the column.

11. A submersible system for providing a table in a swimming pool, the submersible system comprising:
a pedestal base operable to be submerged and placed on a bottom of a swimming pool;
a column having a distal end and proximal end,
the distal end being coupled to the pedestal base,
the column extending perpendicularly from the pedestal base,
the column having an accessory attachment point at the proximal end;
a table coupled to the accessory attachment point; and
at least one detachable weight, the at least one detachable weight being distributed in a balanced manner about the column, the at least one detachable weight serving to hold the pedestal base in place upon the bottom of the swimming pool.

12. The submersible system of claim 11, wherein the at least one weight includes a plurality of rings stacked coaxially on the pedestal base.

13. The submersible system of claim 12, wherein at least one ring of the plurality of rings includes a plurality of ring segments.

14. The submersible system of claim 11, wherein at least one of the pedestal base, and the column, can be filled with water upon being submerged.

15. The submersible system of claim 11, wherein the table and the column have a central opening which can receive an umbrella.

16. The submersible system of claim 11, further comprising at least one seat radially extending from the column.

17. A method of assembling a submersible system for providing an accessory in a swimming pool, the method comprising:
submerging a pedestal base on a bottom of a swimming pool, the pedestal base having a column coupled to the pedestal base,
the column having a distal end and proximal end,
the distal end being coupled to the pedestal base,
the column extending perpendicularly from the pedestal base,
the column having an accessory attachment point at the proximal end;
coupling an accessory to the accessory attachment point; and
securing the pedestal base to the bottom of the swimming pool with at least one detachable weight, the at least one detachable weight being distributed in a balanced manner about the column, the at least one detachable weight serving to hold the pedestal base in place upon the bottom of the swimming pool.

18. The method of claim 17, wherein the at least one weight includes a plurality of rings stacked coaxially on the pedestal base.

19. The method of claim 18, wherein the at least one ring of the plurality of rings includes a plurality of ring segments.

20. The method of claim 17, wherein at least one of the pedestal base, and the column, is adapted to be filled with water upon being submerged.
